(19) United States
(12) Patent Application Publication
(10) Pub. No.: US 2017/0094227 A1
(43) Pub. Date: Mar. 30, 2017

(54) THREE-DIMENSIONAL SPATIAL-AWARENESS VISION SYSTEM

(71) Applicants: KJERSTIN IRJA WILLIAMS, Sunnyvale, CA (US); Brandon M. Booth, Los Angeles, CA (US); Christopher M. Cianci, Burbank, CA (US); Aaron J. Denney, Burbank, CA (US); Shi-Ping Hsu, Pasadena, CA (US); Adrian Kaehler, Boulder Creek, CA (US); Jeffrey Steven Kranski, San Jose, CA (US); Jeremy David Schwartz, Redwood City, CA (US)

(72) Inventors: KJERSTIN IRJA WILLIAMS, Sunnyvale, CA (US); Brandon M. Booth, Los Angeles, CA (US); Christopher M. Cianci, Burbank, CA (US); Aaron J. Denney, Burbank, CA (US); Shi-Ping Hsu, Pasadena, CA (US); Adrian Kaehler, Boulder Creek, CA (US); Jeffrey Steven Kranski, San Jose, CA (US); Jeremy David Schwartz, Redwood City, CA (US)

(73) Assignee: NORTHROP GRUMMAN SYSTEMS CORPORATION, Falls Church, VA (US)

(21) Appl. No.: 14/866,188

(22) Filed: Sep. 25, 2015

(51) Int. Cl. H04N 7/18; G06T 15/20; G06F 3/0484; H04N 13/02; G06F 3/0481

(52) U.S. Cl. CPC H04N 7/181; H04N 13/0242; H04N 13/0292; H04N 13/0282; G06F 3/04817; G06F 3/04842; G06T 15/205; G06T 2210/61

(57) ABSTRACT

A three-dimensional spatial-awareness vision system includes video sensor system(s) mounted to a monitoring platform and having a field of view to monitor a scene of interest and provide real-time video data corresponding to real-time video images. A memory stores model data associated with a rendered three-dimensional virtual representation of the monitoring platform. An image processor combines the real-time video data and the model data to generate image data comprising the rendered three-dimensional virtual representation of the monitoring platform and the real-time video images of the scene of interest superimposed at a field of view relative to the rendered three-dimensional virtual representation of the monitoring platform. A user interface displays the image data to a user at a location and at an orientation based on a location perspective corresponding to a viewing perspective of the user from a virtual location relative to the rendered three-dimensional virtual representation of the monitoring platform.

### TECHNICAL FIELD

This disclosure relates generally to monitoring systems, and more specifically to a three-dimensional spatial-awareness vision system.

### BACKGROUND

In modern society and throughout recorded history, there has always been a demand for surveillance, security, and monitoring measures. Such measures have been used to prevent theft or accidental dangers, unauthorized access to sensitive materials and areas, and in a variety of other applications. Typical modern monitoring systems implement cameras to view a scene of interest, such as based on a real-time (e.g., live) video feed that can provide visual information to a user at a separate location. As an example, multiple cameras can be implemented in a monitoring, security, or surveillance system that can each provide video information to the user from respective separate locations. Monitoring applications that implement a very large number of video feeds that each provide video information of different locations can be cumbersome and/or confusing to a single user, and can be difficult to reconcile spatial distinctions between the different cameras and the images received at multiple cameras.

### SUMMARY

One example includes a three-dimensional spatial-awareness vision system includes video sensor system(s) mounted to a monitoring platform and having a field of view to monitor a scene of interest and provide real-time video data corresponding to real-time video images. A memory stores model data associated with a rendered three-dimensional virtual representation of the monitoring platform. An image processor combines the real-time video data and the model data to generate image data comprising the rendered three-dimensional virtual representation of the monitoring platform and the real-time video images of the scene of interest superimposed at a field of view relative to the rendered three-dimensional virtual representation of the monitoring platform. A user interface displays the image data to a user at a location and at an orientation based on a location perspective corresponding to a viewing perspective of the user from a virtual location relative to the rendered three-dimensional virtual representation of the monitoring platform.

Another embodiment includes a non-transitory computer readable medium comprising instructions that, when executed, are configured to implement a method for providing spatial awareness with respect to a monitoring platform. The method includes receiving real-time video data corresponding to real-time video images of a scene of interest within the geographic region via at least one video sensor system having at least one perspective orientation that defines a field of view. The method also includes ascertaining the three-dimensional features of the scene of interest relative to the at least one video sensor system. The method also includes correlating the real-time video images of the scene of interest with the three-dimensional features of the scene of interest to generate three-dimensional image data. The method also includes accessing model data associated with a rendered three-dimensional virtual representation of the monitoring platform to which the at least one video sensor system is mounted from a memory. The method also includes generating composite image data based on the model data and the three-dimensional image data, such that the composite image data comprises the real-time video images of the scene of interest in a field of view associated with each of a respective corresponding at least one perspective orientation relative to the rendered three-dimensional virtual representation of the monitoring platform. The method further includes displaying the composite image data to a user via a user interface at a location and at an orientation that is based on a location perspective corresponding to a viewing perspective of the user from a given virtual location relative to the rendered three-dimensional virtual representation of the monitoring platform.

Another embodiment includes three-dimensional spatial-awareness vision system. The system includes at least one video sensor system that is mounted to a monitoring platform and has a perspective orientation that defines a field of view, the at least one video sensor system being configured to monitor a scene of interest and to provide real-time video data corresponding to real-time video images of the scene of interest. The system also includes a memory configured to store model data associated with a rendered three-dimensional virtual representation of the monitoring platform and geography data associated with a rendered three-dimensional virtual environment that is associated with a geographic region that includes at least the scene of interest. The system also includes an image processor configured to combine the real-time video data, the model data, and the geography data to generate image data comprising the rendered three-dimensional virtual representation of the monitoring platform superimposed onto the rendered three-dimensional virtual environment at an approximate location corresponding to a physical location of the monitoring platform in the geographic region and the real-time video images of the scene of interest superimposed at a field of view corresponding to a respective corresponding perspective orientation relative to the rendered three-dimensional virtual representation of the monitoring platform. The system further includes a user interface configured to display the image data to a user at a location and at an orientation that is based on a location perspective corresponding to a viewing perspective of the user from a given virtual location relative to the rendered three-dimensional virtual representation of the monitoring platform in the rendered three-dimensional virtual environment.

### BRIEF DESCRIPTION OF THE DRAWINGS

FIG. 1 illustrates an example of a spatial-awareness vision system.

FIG. 2 illustrates an example diagram of a vehicle implementing a spatial-awareness vision system.

FIG. 3 illustrates a first example of composite image data.

FIG. 4 illustrates another example of a spatial-awareness vision system.

FIG. 5 illustrates a second example of composite image data.

FIG. 6 illustrates a third example of composite image data.

FIG. 7 illustrates a fourth example of image data.

FIG. 8 illustrates a fifth example of image data.

FIG. 9 illustrates an example of a method for providing spatial awareness with respect to a monitoring platform.

### DETAILED DESCRIPTION

This disclosure relates generally to monitoring systems, and more specifically to a three-dimensional spatial-awareness vision system. The spatial-awareness vision system includes at least one video sensor system having a perception orientation and being configured to monitor a scene of interest and to provide real-time video data corresponding to real-time video images of the scene of interest. The video sensor system(s) can be affixed to a monitoring platform, which can be a stationary platform or can be a moving platform, such as one or more separately movable vehicles. The scene of interest can correspond to any portion of a geographic region within the perception orientation of the video sensor system, and is thus a portion of the geographic region that is within a line of sight of the video sensor system. For example, multiple video sensor systems can be implemented for monitoring different portions of the geographic region, such that cameras of the video sensor systems can have perspective orientation that define fields of view that overlap with respect to each other to provide contiguous image data, as described herein. The video sensor system(s) can each include a video camera configured to capture the real-time video images and a depth sensor configured to ascertain three-dimensional features of the scene of interest relative to the video camera, such that the real-time video data can be three-dimensional video data, as perceived from different location perspectives.

The spatial-awareness vision system also includes a memory configured to store model data associated with a rendered three-dimensional virtual representation of the monitoring platform (hereinafter “virtual model”), and can also store geography data that is associated with the geographic region that includes at least the scene of interest. As an example, the geography data can include a rendered three-dimensional virtual environment (hereinafter “virtual environment”) that can be a preprogrammed graphical representation of the actual geographic region, having been rendered from any of a variety of graphical software tools to represent the physical features of the geographic region, such that the virtual environment can correspond approximately to the geographic region in relative dimensions and contours. The spatial-awareness vision system can also include an image processor that is configured to combine the real-time video data and the model data, as well as the geography data, to generate composite image data.

Additionally, the spatial-awareness vision system can include a user interface that allows a user to view the real-time video images in the field of view of the vision sensor system(s) from a given location perspective corresponding to a viewing perspective of the user at a given virtual location with respect to the virtual model. The user interface can be configured to enable the user to change the location perspective in any of a variety of perspective angles and distances from the virtual model, for example. The user interface can include a display that is configured to display the composite image data at the chosen location perspective, and thus presents the location perspective as a virtual location of the user in the virtual environment at a viewing perspective corresponding to the virtual location and viewing orientation of the user in the virtual environment. Additionally, the image processor can be further configured to superimpose the real-time video images of the scene of interest onto the virtual environment in the image data at an orientation associated with the location perspective of the user within the virtual environment. As a result, the user can view the real-time video images provided via the video sensor system(s) based on the location perspective of the user in the virtual environment relative to the perspective orientation of the vision sensor system.

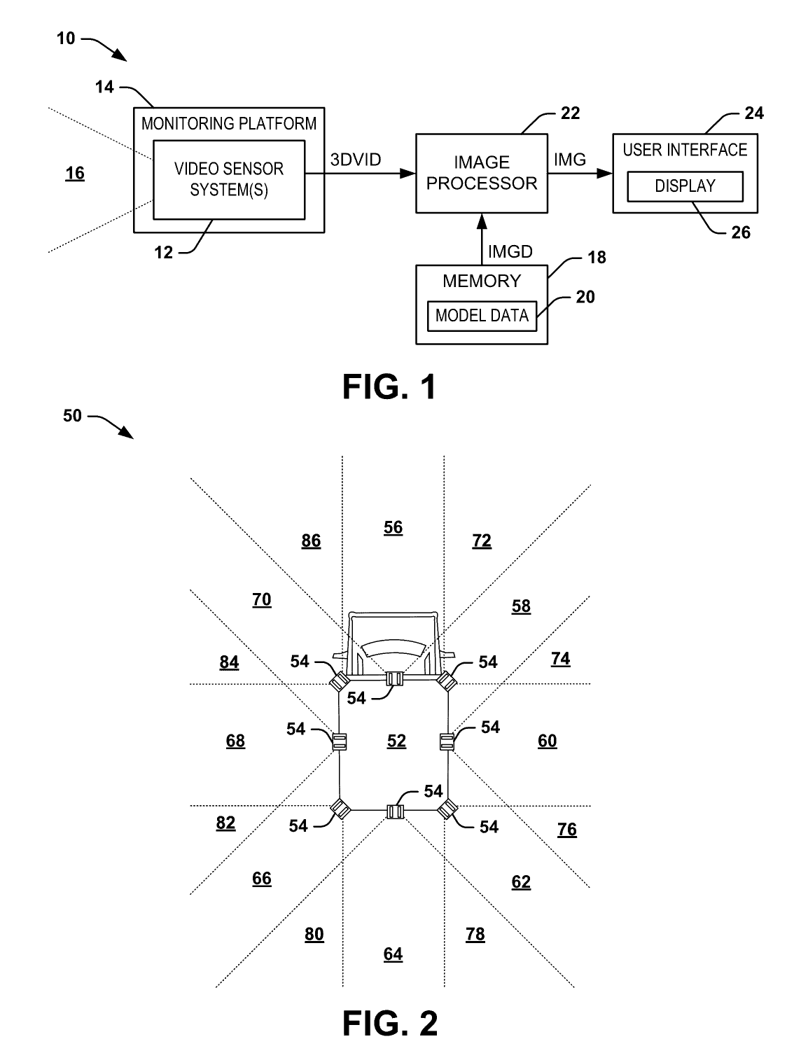

FIG. 1 illustrates an example of a spatial-awareness vision system 10. The spatial-awareness vision system 10 can be implemented in any of a variety of applications, such as security, surveillance, logistics, military operations, or any of a variety of other area monitoring applications. The spatial-awareness vision system 10 includes at least one video sensor system 12 that is affixed to a monitoring platform 14. As an example, the monitoring platform 14 can be configured as a stationary platform, such as a substantially fixed monitoring station (e.g., a wall, pole, bracket, or other platform to which surveillance equipment can be mounted). As another example, the monitoring platform 14 can be configured as a mobile platform, such as a vehicle. The video sensor system(s) 12 are configured to monitor a scene of interest in a geographic region and to provide real-time video data corresponding to real-time video images of the scene of interest. As described herein, the term “geographic region” can describe any region in three-dimensional space in which the spatial-awareness vision system 10 is configured to operate, such as the interior and/or exterior of a building, a facility, a park, a city block, an airport, a battlefield, or any other geographic region for which artificial vision is desired.

For example, the video sensor system(s) 12 can each include a video camera configured to capture real-time video images of the scene of interest. In the example of FIG. 1, the video sensor system(s) 12 has a perspective orientation that defines a field of view 16. As described herein, the term “perspective orientation” describes a physical mounting position and angular orientation of the video camera therein to define the range of vision of the video sensor system 12, and thus the field of view 16 corresponding to a respective portion of the scene of interest of the geographic region that is monitored by the respective video sensor system 12. The video sensor system(s) 12 can also each include a depth sensor configured to ascertain three-dimensional features of the scene of interest relative to the respective video sensor system(s) 12. The depth sensor can be configured as a variety of imaging and/or range-finding devices, such as radar, lidar, acoustic sensors (e.g., sonar), and/or a second video camera arranged in a stereo camera arrangement with the first video camera. Thus, the video sensor system(s) 12 can provide a signal 3DVID that can include the real-time image data and the three-dimensional feature data, which can be correlated as three-dimensional real-time image data, as described in greater detail herein.

In the example of FIG. 1, the spatial-awareness vision system 10 also includes a memory 18 that is configured to store model data 20. The model data 20 can be data associated with a rendered three-dimensional virtual representation of the monitoring platform 14. The rendered three-dimensional virtual representation of the monitoring platform 14 can thus be a rendered three-dimensional graphical representation of the substantially fixed monitoring station or vehicle corresponding to the monitoring platform 14. The model data 20 can also graphical representations of the locations of the video sensor system(s) 12 on the corresponding monitoring platform 14, such as represented by icons or other graphical indicators. In addition, as described in greater detail herein, the memory 18 can also store geography data corresponding to a rendered three-dimensional virtual environment corresponding to at least a portion of the geographic region in which the spatial-awareness vision system 10 operates, and thus includes the scene of interest.

The spatial-awareness vision system 10 can also include an image processor 22 that is configured to combine the real-time video data and three-dimensional feature data 3DVID that is provided via the video sensor system(s) 12 with the model data 20, demonstrated as a signal IMGD, to generate three-dimensional composite image data. The composite image data is thus provided as a signal IMG to a user interface 24, such that a user can view and/or interact with the composite image data via the user interface 24 via a display 26. As described herein, the term “composite image data” corresponds to a composite image that can be displayed to a user via the user interface 24, with the composite image comprising the three-dimensional real-time video data displayed relative to the rendered three-dimensional virtual representation of the monitoring platform 14. Therefore, the composite image data can include the real-time video images of the scene of interest superimposed at a field of view corresponding to a respective corresponding perspective orientation relative to the rendered three-dimensional virtual representation of the monitoring platform 14. In other words, the three-dimensional real-time video images are displayed on the display 26 such that the three-dimensional real-time video images appear spatially and dimensionally the same relative to the rendered three-dimensional virtual representation of the monitoring platform 14 as the three-dimensional features of the scene of interest appear relative to the actual monitoring platform 14 in real-time.

As an example, the user interface 24 can be configured to enable a user to view the composite image data in a “third person manner”. Thus, the display 26 can display the composite image data at a location perspective corresponding to a viewing perspective of the user at a given virtual location relative to the rendered three-dimensional virtual representation of the monitoring platform 14. As described herein, the term “location perspective” is defined as a viewing perspective of the user at a given virtual location having a perspective angle and offset distance relative to the rendered three-dimensional virtual representation of the monitoring platform 14, such that the display 26 simulates a user seeing the monitoring platform 14 and the scene of interest from the given virtual location based on an orientation of the user with respect to the virtual location.

Therefore, the displayed composite image data provided to the user via the user interface 24 demonstrates the location perspective of the user relative to the rendered three-dimensional virtual representation of the monitoring platform 14 and to the scene of interest. Based on the combination of the real-time video data that is provided via the video sensor system(s) 12 with the virtual environment 14, the image processor 22 can superimpose the real-time video images of the scene of interest from the video sensor system(s) 12 relative to the rendered three-dimensional virtual representation of the monitoring platform 14 at an orientation associated with the location perspective of the user. Furthermore, as described in greater detail herein, the user interface 24 can be configured to facilitate user inputs to change a viewing perspective with respect to the composite image data. For example, the user inputs can be implemented to provide six-degrees of motion of the location perspective of the user, and thus including at least one of zooming, rotating, and panning the composite image data, to adjust the location perspective associated with the displayed composite image data. Therefore, the user inputs can change at least one of a perspective angle and offset distance of the given virtual location relative to the rendered three-dimensional virtual representation of the monitoring platform 14. As an example, the user interface 24 can be located at a remote geographic location relative to the video sensor system(s) 12 and/or the image processor 22, and the video sensor system(s) 12 can be located at a remote geographic location relative to the image processor 22. For example, the video sensor system(s) 12, the image processor 22, and/or the user interface 24 can operate on a network, such as a wireless network (e.g., a local-area network (LAN), a wide-area network (WAN), or a variety of other types of systems for communicative coupling).

As a result, the user can view the real-time video images provided via the video sensor system(s) 12 in a three-dimensional manner based on the location perspective of the user in the virtual environment relative to the viewing perspective of the video sensor system(s) 12 to provide a spatial awareness of the three-dimensional features of the scene of interest relative to the monitoring platform 14 without having actual line of sight to any portion of the scene of interest. Accordingly, the spatial-awareness vision system 10 can provide an artificial vision system that can be implemented to provide not only visual information regarding the scene of interest, but also depth-perception and relative spacing of the three-dimensional features of the scene of interest in real-time. As described herein, the viewing perspective of the camera corresponds to the images that are captured by the camera via the associated lens, as perceived by the user. Accordingly, the user can see the real-time video images provided via the video sensor system(s) 12 in a manner that simulates the manner that the user would see the real-time images as perceived from the actual location in the actual geographic region corresponding to the virtual location relative to the rendered three-dimensional virtual representation of the monitoring platform 14.

FIG. 2 illustrates an example diagram 50 of a vehicle 52 implementing a spatial-awareness vision system. The vehicle 52 is demonstrated in the example of FIG. 2 in an overhead view, and can correspond to the monitoring platform 14 in the example of FIG. 1. The vehicle 52 thus includes eight video sensor systems 54 affixed thereto, arranged at each orthogonal edge and each corner of the vehicle 52. Thus, the video sensor systems 54 thus each have respective perspective orientations that provide a first field of view 56, a second field of view 58, a third a field of view 60, a fourth field of view 62, a fifth field of view 64, a sixth field of view 66, a seventh field of view 68, and an eighth field of view 70. While the video sensor systems 54 are each demonstrated as having approximately 90° fields of view, it is to be understood that the fields of view can have other angles and orientations.

As an example, each of the video sensor systems 54 can include a video camera and a depth sensor. For example, each of the video sensor systems 54 can be configured as a stereo pair of video cameras, such that one of the stereo pair of video cameras of the video sensor systems 54 can capture the real-time video images and the other of the stereo pair of video cameras of the video sensor systems 54 can provide depth information based on a relative parallax separation of the features of the scene of interest to ascertain the three-dimensional features of the scene of interest relative to the respective video sensor systems 54. Thus, based on implementing video and depth data, each of the video sensor systems 54 can provide the real-time image data and the three-dimensional feature data that can be combined (e.g., via the image processor 22) to generate three-dimensional real-time image data that can be displayed via the user interface 24 (e.g., via the display 26). As a result, the user can view the composite image data at a location and at an orientation that is based on a location perspective corresponding to a viewing perspective of the user from a given virtual location relative to the rendered three-dimensional virtual representation of the monitoring platform.

In addition, the diagram 50 demonstrates overlaps between the fields of view provided by the video sensor systems 54. In the example of FIG. 2, the diagram 50 includes a first overlap 72 associated with the first and second fields of view 56 and 58, a second overlap 74 associated with the second and third fields of view 58 and 60, a third overlap 76 associated with the third and fourth fields of view 60 and 62, and a fourth overlap 78 associated with the fourth and fifth fields of view 62 and 64. The diagram 50 also includes a fifth overlap 80 associated with the fifth and sixth fields of view 64 and 66, a sixth overlap 82 associated with the sixth and seventh fields of view 66 and 68, a seventh overlap 84 associated with the seventh and eighth fields of view 68 and 70, and an eighth overlap 86 associated with the eighth and first fields of view 70 and 56. The image processor 22 can be configured to identify the overlaps 72, 74, 76, 78, 80, 82, 84, and 86 based on the real-time video data and the depth data provided via the respective video sensor systems 54. Therefore, the image processor 22 can be configured to generate the composite image data as a single contiguous scene of interest based on aligning the real-time video data and depth data generated by each of the video sensor systems 54 at the respective overlaps 72, 74, 76, 78, 80, 82, 84, and 86. Therefore, the composite image data can include the rendered three-dimensional virtual representation of the monitoring platform (e.g., the vehicle 52) and the real-time video images of each of the scenes of interest captured by each of the video sensor systems 54 as contiguously superimposed relative to the fields of view 56, 58, 60, 62, 64, 66, 68, and 70 of each of the video sensor systems 54. Accordingly, the composite image data can be superimposed as substantially surrounding the rendered three-dimensional virtual representation of the vehicle 52 (e.g., the model of the vehicle 52) to display the real-time video images of the corresponding scene of interest surrounding the vehicle 52 to the user via the user interface 24 (e.g., the display 26).

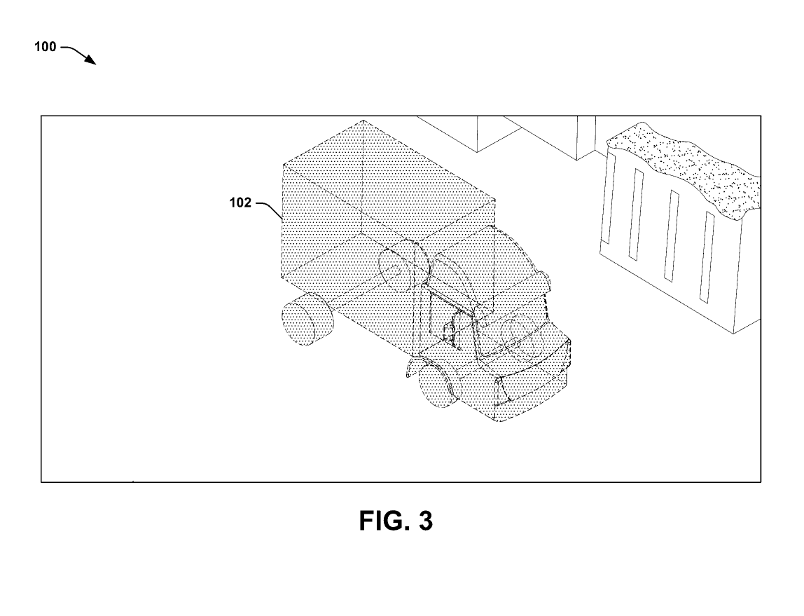

FIG. 3 illustrates a first example of composite image data 100. The composite image data 100 is demonstrated as including a rendered three-dimensional virtual representation of the vehicle 52 in the example of FIG. 2. In the example of FIG. 3, the rendered three-dimensional virtual representation 102 of the vehicle 52 is demonstrated in dashed lines to demonstrate that the rendered three-dimensional virtual representation 102 of the vehicle 52 can be generated in the composite image data as substantially translucent with respect to the scenes of interest captured by the video sensor systems 54. Thus, the user can be able to ascertain the three-dimensional features of the scene of interest that may otherwise have been occluded by the rendered three-dimensional virtual representation 102 of the vehicle 52. The composite image data 100 also demonstrates additional composite image data that can be represented as a single contiguous scene of interest surrounding the rendered three-dimensional virtual representation 102 of the vehicle 52. The composite image data can be generated based on the image processor 22 aligning the real-time video data and depth data generated by each of the video sensor systems 54 at the respective overlaps 72, 74, 76, 78, 80, 82, 84, and 86 between the respective fields of view 56, 58, 60, 62, 64, 66, 68, and 70. Therefore, the composite image data can include the rendered three-dimensional virtual representation of the monitoring platform 102 and the real-time video images of each of the scenes of interest captured by each of the video sensor systems 54 as contiguously superimposed relative to the fields of view 56, 58, 60, 62, 64, 66, 68, and 70 of each of the video sensor systems 54.

In the example of FIG. 3, the composite image data is demonstrated as being displayed to a user from a given location perspective that is offset from the rendered three-dimensional virtual representation 102 of the vehicle 52 by a predetermined distance, and is based on an orientation angle (e.g., azimuth and polar angles in a spherical coordinate system) that corresponds to a view looking diagonally down from between the front and right side of the rendered three-dimensional virtual representation 102 of the vehicle 52. The location perspective can be based on the user implementing a platform-centric view of the composite image data, in which the location perspective of the user is offset from and substantially centered upon the rendered three-dimensional virtual representation of the monitoring platform 102. In the platform-centric view, as an example, the user can provide inputs via the user interface 24 to move, zoom, and/or change viewing orientation via graphical or hardware controls to change the location perspective. Therefore, the user can view the real-time video images of the scene of interest from substantially any angle and/or any distance with respect to the rendered three-dimensional virtual representation 102 of the vehicle 52. Additionally, as described in greater detail herein, the user can implement the user interface 24 to switch to a different view, such as a camera-perspective view associated with the location perspective of the user being substantially similar to the perspective orientation of a respective one of the video sensor systems 54. Furthermore, as also described in greater detail herein, the composite image data can be superimposed on a virtual environment, such as stored in the memory 18. Thus, the composite image data can be displayed to provide spatial awareness within the virtual environment that can correspond to the geographic region in which the vehicle 52 is located.

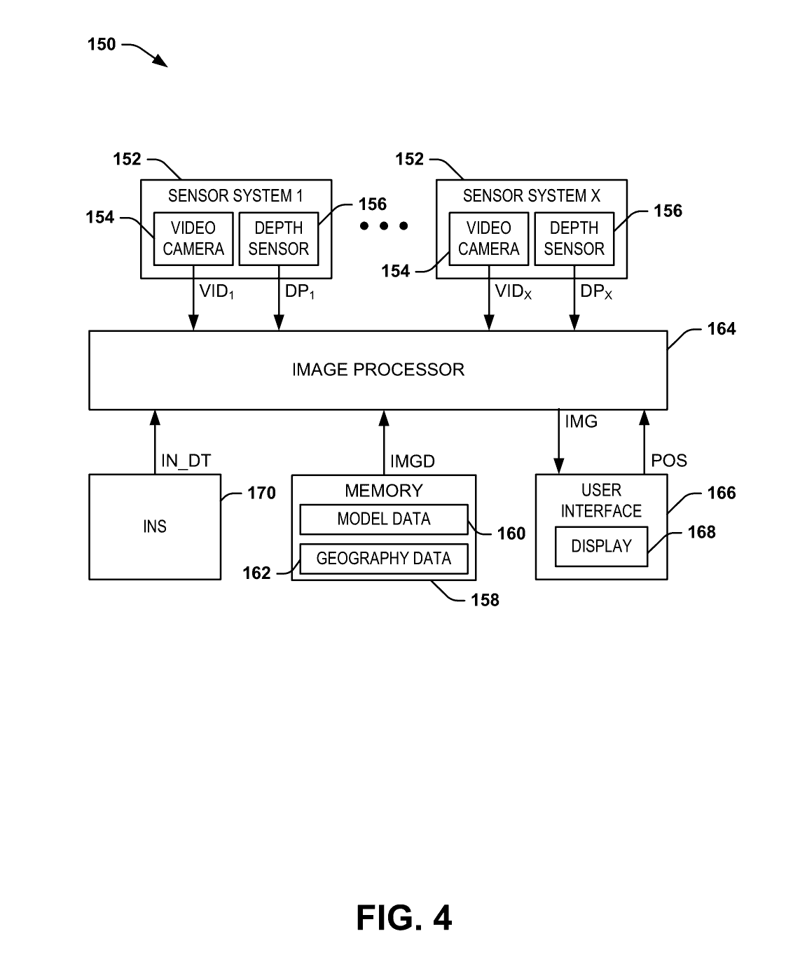

FIG. 4 illustrates another example of a spatial-awareness vision system 150. The spatial-awareness vision system 150 can be implemented in any of a variety of applications, such as security, surveillance, logistics, military operations, or any of a variety of other area monitoring applications. As an example, the spatial-awareness vision system 150 can correspond to the spatial-awareness vision system 150 that provides the composite image data in the example of FIG. 3.

The spatial-awareness vision system 150 includes a plurality X of video sensor systems 152 that can be affixed to a monitoring platform (e.g., the vehicle 52), where X is a positive integer. Each of the video sensor systems 152 includes a video camera 154 and a depth sensor 156. The video sensor systems 152 are configured to monitor a scene of interest within a field of view, as defined by a perspective orientation of the respective video camera 154 thereof, in a geographic region and to provide real-time video data corresponding to real-time video images of the scene of interest. In the example of FIG. 4, the video camera 154 in each of the video sensor systems 152 provides real-time video data VID₁ through VID_{X} corresponding to the real-time video images of the respective scenes of interest defined by the fields of view. The depth sensor 156 of each of the video sensor systems 152 is configured to ascertain three-dimensional features of the respective scene of interest of the field of view defined by the respective video camera 154 relative to the respective video sensor system 152. The depth sensor can be configured as a variety of imaging and/or range-finding devices, such as radar, lidar, acoustic sensors (e.g., sonar), and/or a second video camera arranged in a stereo camera arrangement with the video camera 154. In the example of FIG. 4, the depth sensor 156 in each of the video sensor systems 152 provides three-dimensional feature data DP₁ through DP_{X} corresponding to the three-dimensional features of the respective scenes of interest defined by the fields of view of and relative to the corresponding video cameras 154 in each of the video sensor systems 152.

In the example of FIG. 4, the spatial-awareness vision system 150 also includes a memory 158 that is configured to store model data 160 and geography data 162. The model data 160 can be data associated with a rendered three-dimensional virtual representation of the monitoring platform (e.g., the rendered three-dimensional virtual representation 102 of the vehicle 52). The rendered three-dimensional virtual representation of the monitoring platform can thus be a rendered three-dimensional graphical representation of the substantially fixed monitoring station or vehicle corresponding to the monitoring platform. The model data 160 can also graphical representations of the locations of the video sensor systems 152 on the corresponding monitoring platform, such as represented by icons or other graphical indicators. The geography data 162 corresponds to a rendered three-dimensional virtual environment (hereinafter, “virtual environment”) corresponding to at least a portion of the geographic region in which the spatial-awareness vision system 150 operates, and thus includes the scene of interest. As described herein, the virtual environment describes a preprogrammed rendered three-dimensional graphical representation of the actual geographic region, having been rendered from any of a variety of graphical software tools to represent the substantially static physical features of the geographic region, such that the virtual environment can correspond approximately to the geographic region in relative dimensions and contours. For example, the virtual environment can include buildings, roads, walls, doors, hallways, rooms, hills, and/or a variety of other substantially non-moving features of the geographic region. As an example, the geography data 162 can be updated in response to physical changes to the static features of the geographic region, such as based on construction of or demolition of a structure. Thus, the virtual environment can be maintained in a substantially current state of the geographic region. As another example, the geography data 162 can be preprogrammed and saved in entirety in the memory 158, or can be streamed from an external data source, such that the geography data 162 can correspond to a virtual environment defined by a proprietary navigation software.

The spatial-awareness vision system 150 also includes an image processor 164 that receives the real-time video data VID₁ through VID_{X} and the three-dimensional feature data DP₁ through DP_{X} from the respective video sensor systems 152, and receives the model data 160 and geography data 162, demonstrated collectively as via a signal IMGD. In response, the image processor 164 correlates the real-time video data VID₁ through VID_{X} and the three-dimensional feature data DP₁ through DP_{X} to generate three-dimensional real-time image data. The three-dimensional real-time image data can thus be combined with the model data 160 and the geography data 162 to generate three-dimensional composite image data. The composite image data is thus provided as a signal IMG to a user interface 166, such that a user can view and/or interact with the composite image data via the user interface 166 via a display 168. Therefore, the composite image data can include the real-time video images of the scenes of interest superimposed at the respective fields of view corresponding to the respective corresponding perspective orientations of the video sensor systems 152 relative to the rendered three-dimensional virtual representation of the monitoring platform. In other words, the three-dimensional real-time video images are displayed on the display 168 such that the three-dimensional real-time video images appear spatially and dimensionally the same relative to the rendered three-dimensional virtual representation of the monitoring platform as the three-dimensional features of the scene of interest appear relative to the actual monitoring platform in real-time.

In addition, the rendered three-dimensional virtual representation of the monitoring platform can be demonstrated as superimposed on the virtual environment defined by the geography data 162, such that the real-time video images can likewise be superimposed onto the virtual environment. As a result, the real-time video images can be demonstrated three-dimensionally in a spatial context in the virtual environment, thus providing real-time video display of the scene of interest in the geographic area that is demonstrated graphically by the virtual environment associated with the geography data 162. In the example of FIG. 4, the spatial-awareness vision system 150 includes an inertial navigation system (INS) 170 that can be coupled to the monitoring platform and which is configured to provide navigation data IN_DT to the image processor 164. As an example, the navigation data IN_DT can include location data, such as global navigation satellite system (GNSS) data, and/or inertial data associated with the monitoring platform. The image processor 164 can thus implement the navigation data IN_DT to adjust the composite image data based on changes to the physical location of the monitoring platform in the geographic region. Thus, the display 168 can demonstrate the motion of the monitoring platform in real-time within the virtual environment, and can continuously update the superimposed real-time video images as the monitoring platform moves. In addition, the user interface 166 can facilitate user inputs POS to control the different perspectives of the video cameras 164, such as to change to a camera-perspective view of the composite image data, or to control the perspective orientation of one or more of the video cameras 164.

Therefore, the displayed composite image data provided to the user via the user interface 166 demonstrates the location perspective of the user relative to the rendered three-dimensional virtual representation of the monitoring platform and to the scene of interest in the virtual environment corresponding to the geographic region. Based on the combination of the real-time video data that is provided via the video sensor systems 152 with the virtual environment 154, the image processor 164 can superimpose the real-time video images of the scene of interest from the video sensor systems 152 relative to the rendered three-dimensional virtual representation of the monitoring platform at an orientation associated with the location perspective of the user. Furthermore, the user interface 166 can be configured to facilitate the user inputs POS to at least one of zoom, rotate, and pan the composite image data to adjust the location perspective associated with the displayed composite image data, and thus change at least one of a perspective angle and offset distance of the given virtual location relative to the rendered three-dimensional virtual representation of the monitoring platform. Therefore, at a given virtual location in the virtual environment, the user can change a viewing orientation to “see” in 360° in both azimuth and polar angles in a spherical coordinate system from the given virtual location in the virtual environment. As an example, the user interface 166 can be located at a remote geographic location relative to the video sensor systems 152 and/or the image processor 164, and the video sensor systems 152 can be located at a remote geographic location relative to the image processor 164. For example, the video sensor systems 152, the image processor 164, and/or the user interface 166 can operate on a network, such as a wireless network (e.g., a local-area network (LAN), a wide-area network (WAN), or a variety of other types of systems for communicative coupling). As an example, with reference to the examples of FIGS. 2 and 3, the user interface 166 can be located within the vehicle 52, or can be located at a remote station that is geographically separate from the vehicle 52.

As a result, the user can view the real-time video images provided via the video sensor systems 152 in a three-dimensional manner based on the location perspective of the user in the virtual environment relative to the viewing perspective of the video sensor systems 152 to provide a spatial awareness of the three-dimensional features of the scene of interest relative to the monitoring platform without having actual line of sight to any portion of the scene of interest within the geographic region. Accordingly, the spatial-awareness vision system 150 can provide an artificial vision system that can be implemented to provide not only visual information regarding the scene of interest, but also depth-perception and relative spacing of the three-dimensional features of the scene of interest and the geographic region in real-time. As described herein, the viewing perspective of the camera corresponds to the images that are captured by the camera via the associated lens, as perceived by the user. Accordingly, the user can see the real-time video images provided via the video sensor systems 152 in a manner that simulates the manner that the user would see the real-time images as perceived from the actual location in the actual geographic region corresponding to the virtual location relative to the rendered three-dimensional virtual representation of the monitoring platform.

While the example of FIG. 4 describes that the video sensor systems 152 include the respective depth sensors 156 and that the INS 170 is associated with the monitoring platform. However, it is to be understood that the spatial-awareness vision system 150 can be configured in a variety of other ways. For example, the depth sensors 156 can be omitted from the video sensor systems 152, and the video sensor systems 152 can each include an INS (e.g., similar to the INS 170) to provide location data. Thus, the geography data 162 can correspond to three-dimensional feature data with respect to static features of the geographic region, such that the image processor 164 can generate the composite image data based on superimposing the real-time video images onto the virtual environment based on a known relationship of the physical location of the video cameras 164 relative to the known three-dimensional static features of the virtual environment defined in the geography data 162. As an example, the spatial-awareness vision system 150 can include a single depth sensor or multiple depth sensors that are not specific to the video sensor systems 152, such that the depth information can be combined with the physical location data associated with the video sensor systems 152 via respective INS systems of the video sensor systems 152. Accordingly, the composite image data can be generated by the image processor 164 in a variety of ways.

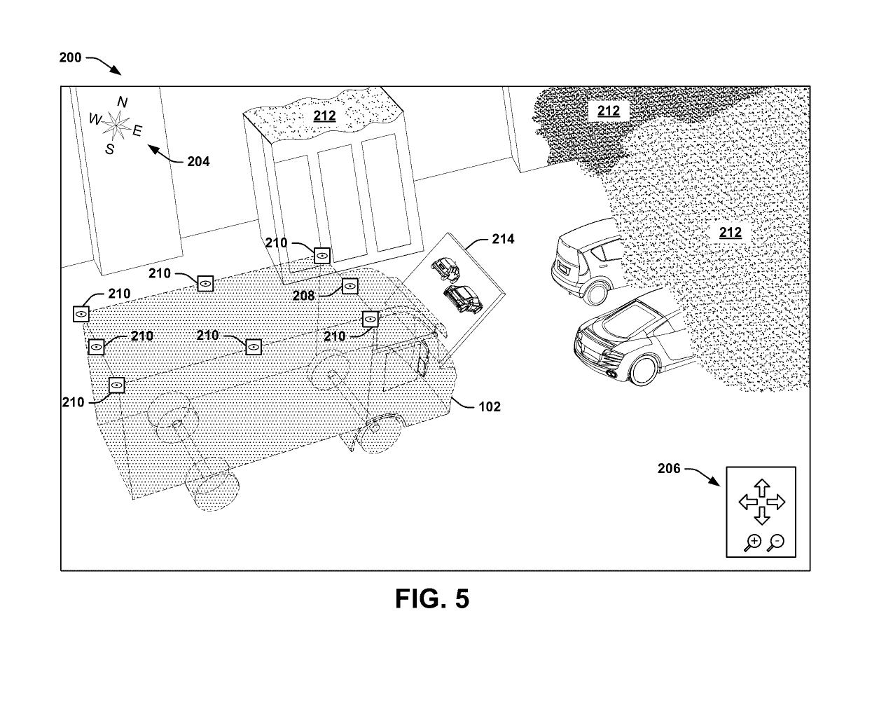

FIG. 5 illustrates a second example of composite image data 200. The composite image data 200 is demonstrated substantially similar as the composite image data 100 in the example of FIG. 3, and thus includes the rendered three-dimensional virtual representation 102 of the vehicle 52 demonstrated at a different location perspective in a platform-centric view. In the example of FIG. 5, the composite image data 200 includes a compass rose 204 and a set of controls 206 that can assist the user in navigating through the virtual environment 58. As an example, the set of controls 206 can be implemented by the user to provide the user inputs POS, such as to allow the user to zoom in and out in the overhead view, such as to see more or less of the portion of the surrounding virtual environment, and/or to change a location perspective via an orientation angle of the user's view of the composite image data.

The composite image data 200 includes a plurality of camera icons that are demonstrated at virtual locations that can correspond to respective approximate three-dimensional locations of video sensor systems (e.g., the video sensor systems 54 in the example of FIG. 2 and/or the video sensor systems 152 in the example of FIG. 4) affixed to the vehicle 52. The camera icons are demonstrated as a first camera icon 208 and a plurality of additional camera icons 210 arranged about the rendered three-dimensional virtual representation 102 of the vehicle 52. In the example of FIG. 5, the camera icons 208 and 210 are demonstrated as square icons having eye symbols therein, but it is to be understood that the camera icons 208 and 210 can be demonstrated in a variety of ways and can include alpha-numeric designations to better distinguish them to the user. In addition, the composite image data 200 includes blurred portions 212 with respect to the real-time video images. As an example, the blurred portions 212 can correspond to portions of the scene of interest that cannot be captured by the video sensor systems 152 or cannot be compiled by the image processor 164 in a meaningful way to a user base on incomplete video data or three-dimensional feature data obtained via the depth sensors (e.g., the depth sensors 156). Therefore, the image processor 164 can be configured to omit the features of the incomplete video data or three-dimensional feature data and overlay the omitted features in a three-dimensional manner. As a result, the user can still comprehend the three-dimensional features of the scene of interest even without a complete representation of the real-time video images superimposed onto the virtual environment.

The user inputs POS that can be provided via the user interface 166 can include selection inputs to select a given one of the camera icons 208 and 210 to implement controls associated with the respective video camera (e.g., a video camera 154). For example, the controls can include moving (e.g., panning) and/or changing a zoom of the respective video camera, and/or changing a location perspective. In the example of FIG. 5, in response to selection of the camera icon 208 by the user, the image processor 164 can be configured to provide a preview of the real-time video images captured by the respective video camera 154 in the video sensor system 152 corresponding to the camera icon 208, demonstrated in the example of FIG. 5 as a real-time video image preview 214. The real-time video image preview 214 demonstrates the real-time video images in the perspective orientation of the camera, such that the real-time video image preview 214 is provided as raw, two-dimensional image data (e.g., without three-dimensional features provided via the respective depth sensor 156). As an example, the real-time video image preview 214 can be provided at a substantially predetermined and/or adjustable size as superimposed onto the virtual environment, demonstrated in the example of FIG. 5 as being substantially centered on the camera icon 208.

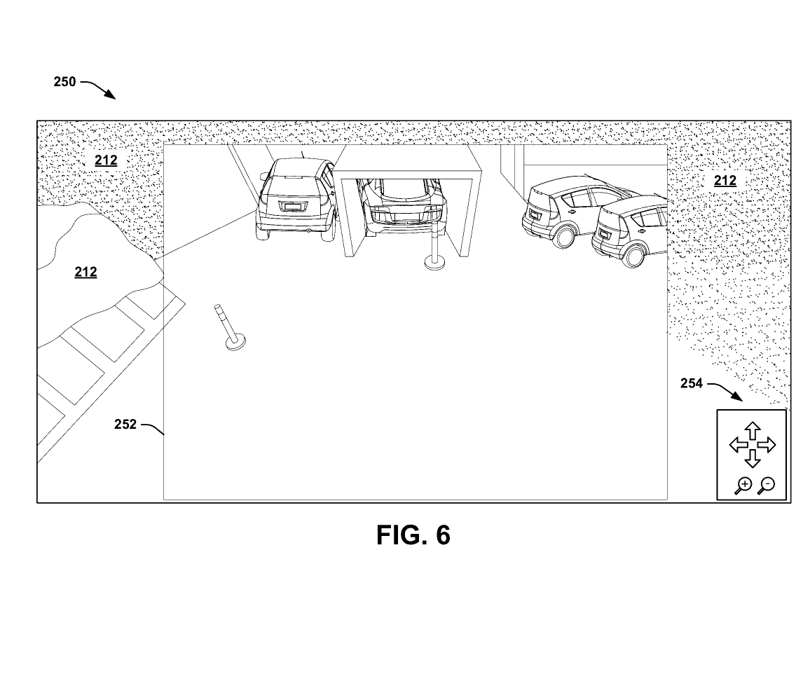

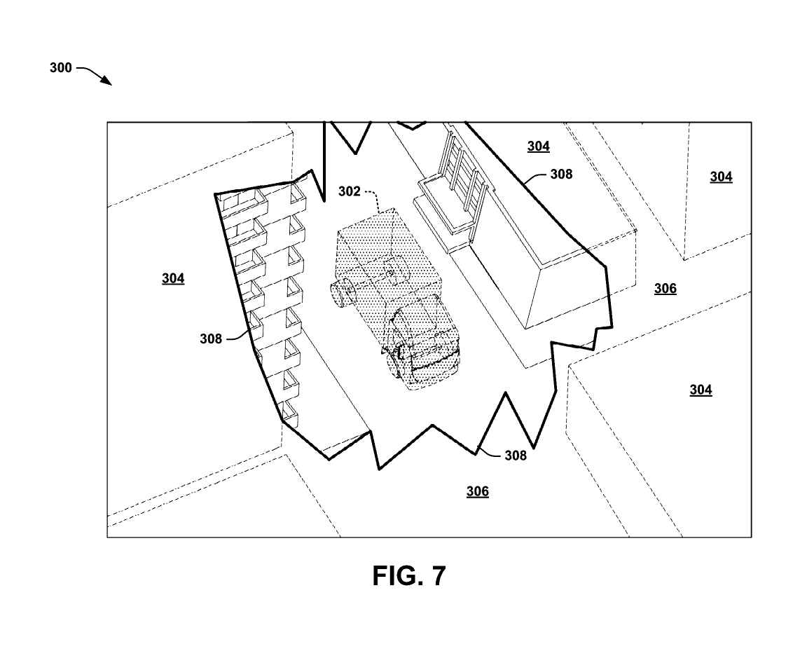

As an example, the user can select the camera icon 208 in a predetermined manner (e.g., a single click) to display the real-time video image preview 214 corresponding to the field of view defined by the perspective orientation of the camera 154 associated with the camera icon 208. Because the real-time video image preview 214 is a preview, it can be provided in a substantially smaller view relative to a camera-perspective view (e.g., as demonstrated in the example of FIG. 6), and can disable camera controls (e.g., zoom and/or directional orientation changes). Additionally, because the real-time video image preview 214 is provided as only a preview, other icons can be superimposed over the real-time video image preview 214 in the example of FIG. 5.

In the example of FIG. 5, the real-time video image preview 214 of the camera 154 associated with the camera icon 208 is demonstrated at a perspective view, and thus a location and orientation, that corresponds to the location perspective of the user in the virtual environment. Because the real-time video image preview 214 is superimposed at a location and orientation that corresponds to the location perspective of the user, the real-time video image preview 214 is displayed in a manner that simulates the manner that the user would see the associated visual content of the real-time video image preview 214 as perceived from the actual location in the actual geographic region corresponding to the virtual location in the virtual environment, but zoomed in from the three-dimensional real-time images superimposed on the virtual environment (i.e., in front of the rendered three-dimensional virtual representation 102 of the vehicle 52). Therefore, as the user changes location perspective in the platform-centric view (e.g., via the set of controls 206), the location and orientation of the real-time video image preview 214 likewise changes accordingly to maintain the simulated view that the user would see the associated visual content of the real-time video image preview 214 as perceived from the actual location in the actual geographic region corresponding to the virtual location in the virtual environment.

The real-time video image preview 214 is one example of a manner in which the real-time video images of the video cameras 154 can be superimposed onto the virtual environment in a two-dimensional manner. FIG. 6 illustrates a third example of composite image data 250. The image data 250 is demonstrated in the camera-perspective view of the video camera 154 associated with the camera icon 208 in the example of FIG. 5. For example, the user can select the camera icon 208 in a second manner that is distinct from the manner in which the camera icon 208 is selected for preview (e.g., a double-click versus a single-click) to switch from the platform-centric view in the composite image data 200 in the respective example of FIG. 5 to select the camera-perspective view of the video camera 154 associated with the camera icon 208. Therefore, in the example of FIG. 6, the camera-perspective view is demonstrated as real-time video images 252 that are superimposed over the virtual environment in a manner that the location perspective of the user and the viewing perspective of the respective camera 154 are substantially the same. Therefore, the location perspective of the user is substantially the same as the perspective orientation of the respective video camera 154 that provides the respective field of view (e.g., the field of view 56). In the example of FIG. 6, the surrounding virtual environment that extends beyond the field of view of the respective video camera 154 (e.g., as dictated by the real-time video images 252) is likewise demonstrated in the composite image data 250, such that the perspective of the respective video camera 154 is superimposed on the virtual environment as coterminous in space with the location perspective of the user in the virtual environment.

The image data 250 includes a set of controls 254 that can be the same as or different from the set of controls 206 in the examples of FIG. 5, and can thus allow the user to manipulate the composite image data 250 in the same or a different manner relative to the composite image data 200 in the respective examples of FIG. 5. For example, the set of controls 254 can correspond to controls for the respective video camera 154 associated with the camera icon 208. For example, the set of controls 254 can include yaw and pitch directional controls to allow the user to change the orientation angle of the respective video camera 154 associated with the camera icon 208 in the camera-perspective view. In response to changes in the orientation angle of the respective video camera 154 associated with the camera icon 208 in the camera-perspective view, the surrounding portions of the virtual environment that extend beyond the field of view of the respective video camera 154 (e.g., as dictated by the respective real-time video images 252) likewise changes in the composite image data 250 to maintain the coterminous display of the perspective orientation of the respective video camera 154 and the location perspective of the user. Additionally, the set of controls 254 can also include zoom controls to zoom the respective video camera 154 associated with the camera icon 208 in and out in the camera-perspective view. The set of controls 254 can also be configured to adjust the respective video camera 154 in other ways, such as to provide six-degrees of motion and/or to implement a range of different types of perspective changes, such as tilt, pan, zoom, rotate, pedestal, dolly, or truck (e.g., as recognized in the film industry). Furthermore, the image data 250 can include an icon that the user can select to switch back to the platform-centric view, such as demonstrated in the example of FIG. 5.

FIG. 7 illustrates a fourth example of composite image data 300. The composite image data 300 is demonstrated as including a rendered three-dimensional virtual representation 302 of the vehicle 52 in the example of FIG. 2. Similar to as described previously, in the example of FIG. 7, the rendered three-dimensional virtual representation 302 of the vehicle 52 is demonstrated in dashed lines to demonstrate that the rendered three-dimensional virtual representation 302 of the vehicle 52 can be generated in the composite image data as substantially translucent with respect to the scenes of interest captured by the video sensor systems 54. The composite image data can be generated based on combining the real-time video data VID₁ through VID_{X}, the three-dimensional feature data DP₁ through DP_{X}, and the data IMGD that includes the model data 160 and the geography data 162. Therefore, the composite image data can include the rendered three-dimensional virtual representation of the monitoring platform 302 and the real-time video images of each of the scenes of interest captured by each of the video sensor systems 152 as contiguously superimposed relative to the rendered three-dimensional virtual representation 302 of the vehicle 52, all of which being displayed as superimposed over the virtual environment defined by the geography data 162. In the example of FIG. 7, the virtual environment is demonstrated as graphical renderings of buildings 304 and streets 306.

In the example of FIG. 7, the composite image data is demonstrated as being displayed to a user from a given location perspective at a given orientation angle and which is offset from the rendered three-dimensional virtual representation 302 of the vehicle 52 by a predetermined distance, which is a larger distance than that demonstrated in the example of FIGS. 3 and 5. The location perspective can be based on the user implementing a platform-centric view of the composite image data, in which the location perspective of the user is offset from and substantially centered upon the rendered three-dimensional virtual representation of the monitoring platform 302. In the platform-centric view, as an example, the user can provide inputs via the user interface 24 to move, zoom, and/or change viewing orientation via graphical or hardware controls to change the location perspective. Therefore, the user can view the real-time video images of the scene of interest from substantially any angle and/or any distance with respect to the rendered three-dimensional virtual representation 302 of the vehicle 52. In the example of FIG. 7, the real-time video images that are displayed extend to a given range that is demonstrated by thick lines 308, beyond which the virtual environment (including the buildings 304 and the streets 306) is displayed absent the real-time video images. The buildings 304 and the streets 306 thus are demonstrated as graphical representations outside of the displayed range of the real-time video images, and include graphical representations of portions of the buildings and streets that are demonstrated within the range of the real-time video images. As an example, the video cameras 154 can have a range with respect to the field of view that can be limited based on the perspective orientation and/or a resolution, such that the image processor 164 can be configured to superimpose the real-time video data only up to a certain predetermined range. Thus, the image processor 164 can limit the superimposed real-time video images to images that can be identifiable to a user, such as based on a range and/or resolution threshold, to facilitate greater aesthetic quality of the real-time video images provided by the spatial-awareness vision system 150.

In addition, the image processor 164 can receive the navigation data IN_DT from the INS 170 to update the composite image data as the vehicle 52 moves within the geographic region. As an example, the navigation data IN_DT can include location data (e.g., GNSS data) and/or inertial data associated with the vehicle 52, such that the image processor 164 can implement the navigation data IN_DT to adjust the composite image data based on changes to the physical location of the vehicle 52 in the geographic region. For example, the image processor 164 can substantially continuously change the position of the rendered three-dimensional virtual representation 302 of the vehicle 52 in the virtual environment based on changes to the physical location of the vehicle 52 in the geographic region. Thus, the display 168 can demonstrate the motion of the vehicle 52 in real-time within the virtual environment. Additionally, because the real-time image data is associated with video images in real time, the image processor can continuously update the superimposed real-time video images as the vehicle 52 moves. Therefore, unrevealed video images of the virtual environment become visible as the scene of interest of the geographic region enter the respective field of view of the video camera(s) 154, and previously revealed video images of the virtual environment are replaced by the virtual environment as the respective portions of the geographic region leave the respective field of view of the video camera(s) 154. Accordingly, the image processor 164 can generate the composite image data substantially continuously in real time to demonstrate changes to the scene of interest via the real-time video images on the display 168 as the vehicle 52 moves within the geographic region.

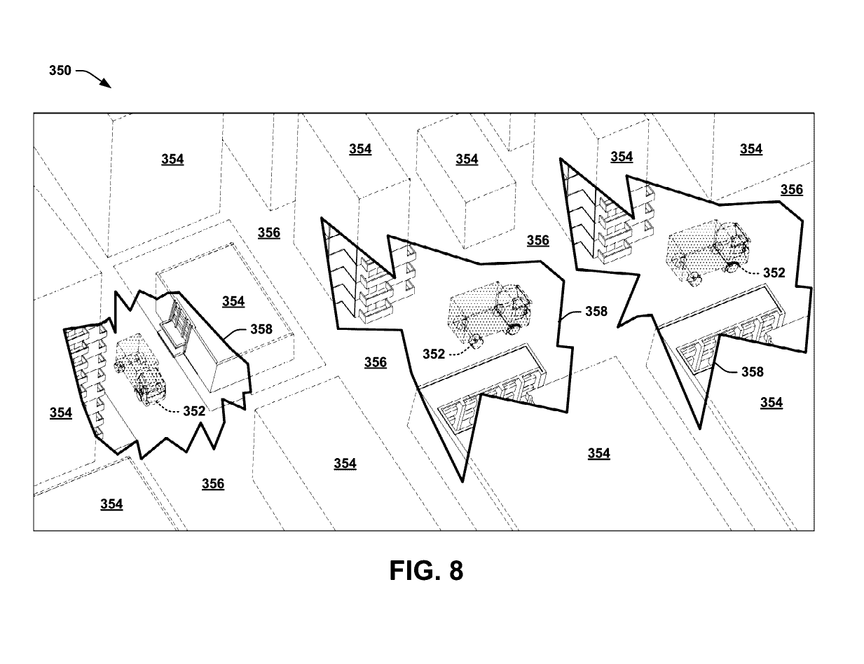

As described herein, the spatial-awareness vision system 150 is not limited to implementation on a single monitoring platform, but can implement a plurality of monitoring platforms with respective sets of video sensor systems 152 affixed to each of the monitoring platforms. FIG. 8 illustrates a fifth example of image data 350. The composite image data 350 is demonstrated as including a plurality of rendered three-dimensional virtual representations 352 that each correspond to a respective vehicle 52 in the example of FIG. 2. Similar to as described previously, in the example of FIG. 8, the rendered three-dimensional virtual representations 352 of vehicles 52 are demonstrated in dashed lines to demonstrate that the rendered three-dimensional virtual representations 352 of vehicles 52 can be generated in the composite image data as substantially translucent with respect to the scenes of interest captured by the video sensor systems 54. The composite image data can be generated based on combining the real-time video data VID₁ through VID_{X} and the three-dimensional feature data DP₁ through DP_{X} from each of the sets of video sensor systems 152 associated with each of the respective vehicles 52, which can thus be combined with the data IMGD that includes the model data 160 associated with each of the vehicles 52 and the geography data 162. Therefore, the composite image data can include the rendered three-dimensional virtual representation of the monitoring platform 352 and the real-time video images of each of the scenes of interest captured by each of the video sensor systems 152 as contiguously superimposed relative to the rendered three-dimensional virtual representations 352 of vehicles 52, all of which being displayed as superimposed over the virtual environment defined by the geography data 162. In the example of FIG. 8, the virtual environment is demonstrated as graphical renderings of buildings 354 and streets 356. The rendered three-dimensional virtual representations 352 of vehicles 52 can be displayed in the virtual environment at positions relative to each other based on the navigation data IN_DT provided from an INS 170 associated with each respective one of the vehicles 52.

In the example of FIG. 8, the composite image data is demonstrated as being displayed to a user from a given location perspective at a given orientation angle and which is offset from the rendered three-dimensional virtual representations 352 of vehicles 52 by a predetermined distance, which is a larger distance than that demonstrated in the example of FIGS. 3 and 5. The location perspective can be based on the user implementing a platform-centric view of the composite image data with respect to a single one of the rendered three-dimensional virtual representations 352 of vehicles 52, in which the location perspective of the user is offset from and substantially centered upon the rendered three-dimensional virtual representation of the respective one of the monitoring platforms 352. Alternatively, the location perspective can correspond to a fixed point with respect to the virtual environment, such that the rendered three-dimensional virtual representations 352 of vehicles 52 can move relative to the fixed point, and such that the user can provide inputs POS via the user interface 164 to adjust the fixed point associated with the virtual environment in three-dimensional space (e.g., to move, zoom, and/or change viewing orientation via graphical or hardware controls to change the location perspective).

In the example of FIG. 8, the real-time video images that are displayed extend from each of the rendered three-dimensional virtual representations 352 of vehicles 52 to a given range that is demonstrated by dashed lines 358, beyond which the virtual environment (including the buildings 354 and the streets 356) is displayed absent the real-time video images. The buildings 354 and the streets 356 thus are demonstrated as graphical representations outside of the displayed range of the real-time video images, and include graphical representations of portions of the buildings and streets that are demonstrated within the range of the real-time video images. Similar to as described previously in the example of FIG. 7, the video cameras 154 can have a range with respect to the field of view that can be limited based on the perspective orientation and/or a resolution, such that the image processor 164 can be configured to superimpose the real-time video data only up to a certain predetermined range. Thus, the image processor 164 can limit the superimposed real-time video images to images that can be identifiable to a user, such as based on a range and/or resolution threshold, to facilitate greater aesthetic quality of the real-time video images provided by the spatial-awareness vision system 150. In addition, as also described previously regarding the example of FIG. 7, the image processor 164 can receive the navigation data IN_DT from the INS 170 associated with each of the vehicles 52 to update the composite image data as the respective vehicles 52 move within the geographic region. Thus, the display 168 can demonstrate the motion of the vehicles 52 in real-time within the virtual environment, and can continuously update the superimposed real-time video images as the vehicles 52 move.

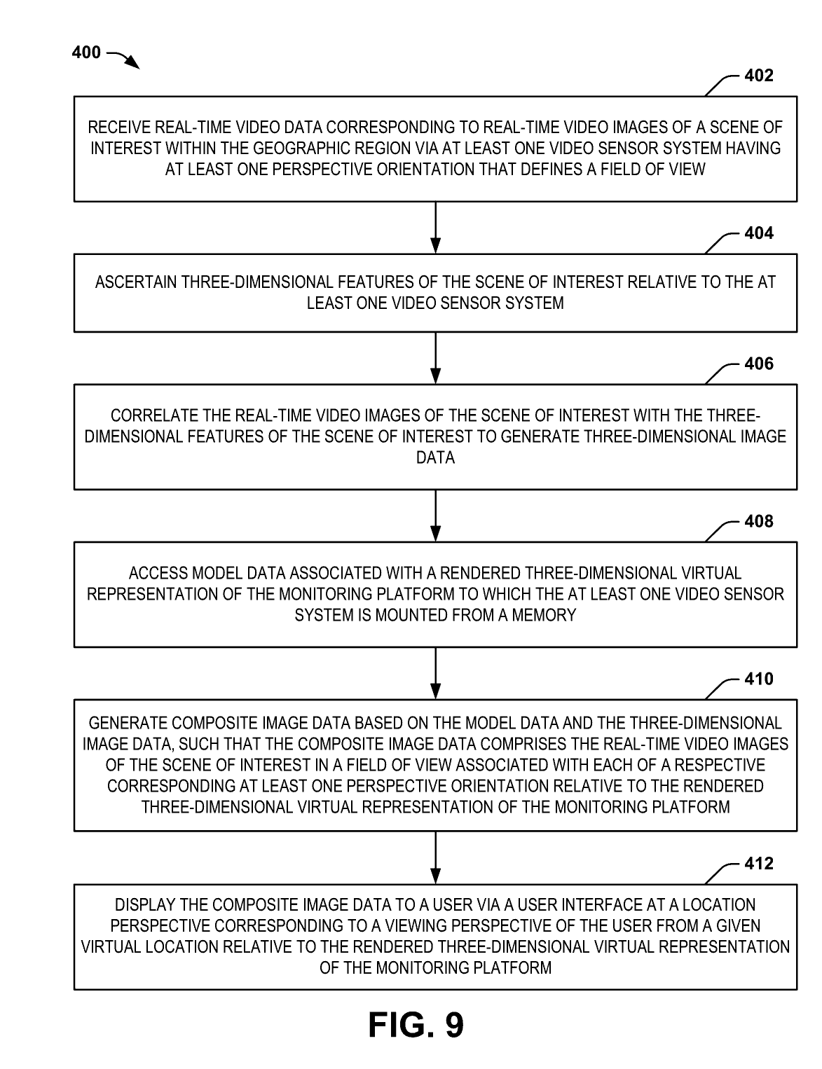

In view of the foregoing structural and functional features described above, a methodology in accordance with various aspects of the present invention will be better appreciated with reference to FIG. 9. While, for purposes of simplicity of explanation, the methodology of FIG. 9 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 9 illustrates an example of a method 400 for providing spatial awareness with respect to a monitoring platform (e.g., the monitoring platform 14). At 402, real-time video data (e.g., the video data VID₁ through VID_{X}) corresponding to real-time video images of a scene of interest within the geographic region is received via at least one video sensor system (e.g., the video sensor system(s) 12) having at least one perspective orientation that defines a field of view (e.g., the field of view 16). At 404, three-dimensional features of the scene of interest relative to the at least one video sensor system are ascertained. At 406, the real-time video images of the scene of interest are correlated with the three-dimensional features of the scene of interest to generate three-dimensional image data (e.g., the three-dimensional image data 3DVID). At 408, model data (e.g., the model data 20) associated with a rendered three-dimensional virtual representation of the monitoring platform to which the at least one video sensor system is mounted is accessed from a memory (e.g., the memory 18). At 410, composite image data (e.g., the composite image data IMG) based on the model data and the three-dimensional image data is generated. The composite image data can include the real-time video images of the scene of interest in a field of view associated with each of a respective corresponding at least one perspective orientation relative to the rendered three-dimensional virtual representation of the monitoring platform. At 412, the composite image data is displayed to a user via a user interface (e.g., the user interface 24) at a location perspective corresponding to a viewing perspective of the user from a given virtual location relative to the rendered three-dimensional virtual representation of the monitoring platform.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A three-dimensional spatial-awareness vision system comprising:
at least one video sensor system that is mounted to a monitoring platform and has a perspective orientation that defines a field of view, the at least one video sensor system being configured to monitor a scene of interest and to provide real-time video data corresponding to real-time video images of the scene of interest;
a memory configured to store model data associated with a rendered three-dimensional virtual representation of the monitoring platform;
an image processor configured to combine the real-time video data and the model data to generate composite image data comprising the rendered three-dimensional virtual representation of the monitoring platform and the real-time video images of the scene of interest superimposed at a field of view corresponding to a respective corresponding perspective orientation relative to the rendered three-dimensional virtual representation of the monitoring platform; and
a user interface configured to display the composite image data to a user at a location and at an orientation that is based on a location perspective corresponding to a viewing perspective of the user from a given virtual location relative to the rendered three-dimensional virtual representation of the monitoring platform.

2. The system of claim 1, wherein the at least one video sensor system comprises:
a video camera configured to capture the real-time video images of the scene of interest; and
a depth sensor configured to ascertain three-dimensional features of the scene of interest relative to the video camera, wherein the image processor is configured to correlate the real-time video images of the scene of interest with the three-dimensional features of the scene of interest to provide the real-time video data as three-dimensional real-time video data.

3. The system of claim 2, wherein the video camera is a first video camera, wherein the depth sensor is a second video camera, such that the first and second video cameras operate as a stereo camera pair to provide the three-dimensional real-time video data.

4. The system of claim 1, wherein the user interface is further configured to enable the user to provide six-degrees of motion with respect to the location perspective associated with the displayed composite image data with respect to a perspective angle and offset distance of the given virtual location relative to the rendered three-dimensional virtual representation of the monitoring platform.

5. The system of claim 1, wherein the memory is further configured to store geography data associated with a rendered three-dimensional virtual environment that is associated with a geographic region that includes at least the scene of interest, wherein the image processor is configured to combine the real-time video data, the model data, and the geography data to generate the composite image data, such that the composite image data comprises the rendered three-dimensional virtual representation of the monitoring platform superimposed onto the rendered three-dimensional virtual environment at an approximate location corresponding to a physical location of the monitoring platform in the geographic region.

6. The system of claim 5, further comprising an inertial navigation system configured to provide location and inertial navigation data to the image sensor to adjust the composite image data based on changes to the physical location of the monitoring platform in the geographic region.

7. The system of claim 1, wherein the user interface is further configured to enable the user to view the composite image data in one of a platform-centric view and a camera-perspective view, wherein the platform-centric view is associated with the location perspective of the user being offset from and substantially centered upon the rendered three-dimensional virtual representation of the monitoring platform, wherein the camera-perspective view is associated with the location perspective of the user being substantially similar to the perspective orientation of a respective one of the at least one video sensor system.

8. The system of claim 7, wherein the user interface is further configured to enable the user to preview the camera-perspective view of the respective one of the at least one video sensor system from the platform-centric view.

9. The system of claim 7, wherein the user interface is further configured to enable the user to select the camera-perspective view by selecting a video icon via the user interface, the camera icon corresponding to a three-dimensional physical location of the respective one of the at least one video sensor system with respect to the mounting fixture, the camera icon being superimposed on the rendered three-dimensional virtual representation of the monitoring platform via the image processor.

10. The system of claim 1, wherein the at least one video sensor system comprises a plurality of video sensor systems, wherein a field of view of each of the plurality of video sensor systems overlaps with a field of view of at least one other of the plurality of video sensor systems, wherein the image processor is configured to combine the real-time video data associated with each of the plurality of video sensor systems and the model data to generate the composite image data comprising the rendered three-dimensional virtual representation of the monitoring platform and the real-time video images of each of a plurality of scenes of interest contiguously superimposed relative to the field of view of each of the respective plurality of video sensor systems.

11. The system of claim 1, wherein the at least one video sensor system is a first at least one video sensor system that is mounted to a first monitoring platform, the system further comprising a second at least one video sensor system that is mounted to a second monitoring platform that is movably independent of the first monitoring platform, wherein the user interface is configured to display the composite image data to the user at a location and at an orientation that is based on a location perspective corresponding to a viewing perspective of the user from a given virtual location relative to rendered three-dimensional virtual representations of the first and second monitoring platforms.

12. A non-transitory computer readable medium comprising instructions that, when executed, are configured to implement a method for providing spatial awareness with respect to a monitoring platform, the method comprising:
receiving real-time video data corresponding to real-time video images of a scene of interest within a geographic region via at least one video sensor system having at least one perspective orientation that defines a field of view;
ascertaining three-dimensional features of the scene of interest relative to the at least one video sensor system;
correlating the real-time video images of the scene of interest with the three-dimensional features of the scene of interest to generate three-dimensional image data;
accessing model data associated with a rendered three-dimensional virtual representation of a monitoring platform to which the at least one video sensor system is mounted from a memory;
generating composite image data based on the model data and the three-dimensional image data, such that the composite image data comprises the real-time video images of the scene of interest in a field of view associated with each of a respective corresponding at least one perspective orientation relative to the rendered three-dimensional virtual representation of the monitoring platform; and
displaying the composite image data to a user via a user interface at a location perspective corresponding to a viewing perspective of the user from a given virtual location relative to the rendered three-dimensional virtual representation of the monitoring platform.

13. The medium of claim 12, wherein each of the at least one video sensor system comprises a first video camera and a second video camera, wherein receiving the real-time video data comprises receiving the real-time video data via the first video camera, and wherein ascertaining the three-dimensional features of the scene of interest comprises ascertaining a relative distance of the three-dimensional features of the scene of interest via the second at least one video camera.

14. The medium of claim 12, further comprising facilitating user inputs via the user interface to enable the user to provide six-degrees of motion with respect to the location perspective associated with the displayed composite image data with respect to a perspective angle and offset distance of the given virtual location relative to the rendered three-dimensional virtual representation of the monitoring platform.

15. The medium of claim 12, further comprising accessing geography data associated with a rendered three-dimensional virtual environment that is associated with a geographic region that includes at least the scene of interest from the memory, wherein generating the composite image data comprises generating composite image data based on the model data, the geography data, and the three-dimensional image data, such that the composite image data comprises the rendered three-dimensional virtual representation of the monitoring platform superimposed onto the rendered three-dimensional virtual environment at an approximate location corresponding to a physical location of the monitoring platform in the geographic region.

16. The system of claim 15, further comprising:
receiving location and inertial navigation data via an inertial navigation system; and
adjusting the composite image data based on changes to the physical location of the monitoring platform in the geographic region.

17. A three-dimensional spatial-awareness vision system comprising:
at least one video sensor system that is mounted to a monitoring platform and has a perspective orientation that defines a field of view, the at least one video sensor system being configured to monitor a scene of interest and to provide real-time video data corresponding to real-time video images of the scene of interest;
a memory configured to store model data associated with a rendered three-dimensional virtual representation of the monitoring platform and geography data associated with a rendered three-dimensional virtual environment that is associated with a geographic region that includes at least the scene of interest;
an image processor configured to combine the real-time video data, the model data, and the geography data to generate image data comprising the rendered three-dimensional virtual representation of the monitoring platform superimposed onto the rendered three-dimensional virtual environment at an approximate location corresponding to a physical location of the monitoring platform in the geographic region and the real-time video images of the scene of interest superimposed at a field of view corresponding to a respective corresponding perspective orientation relative to the rendered three-dimensional virtual representation of the monitoring platform; and
a user interface configured to display the image data to a user at a location and at an orientation that is based on a location perspective corresponding to a viewing perspective of the user from a given virtual location relative to the rendered three-dimensional virtual representation of the monitoring platform in the rendered three-dimensional virtual environment.

18. The system of claim 17, wherein the user interface is further configured to enable the user to provide six-degrees of motion with respect to the location perspective associated with the displayed image data with respect to a perspective angle and offset distance of the given virtual location relative to the rendered three-dimensional virtual representation of the monitoring platform.

19. The system of claim 17, wherein the at least one video sensor system comprises:
a video camera configured to capture the real-time video images of the scene of interest; and
a depth sensor configured to ascertain three-dimensional features of the scene of interest relative to the video camera, wherein the image processor is configured to correlate the real-time video images of the scene of interest with the three-dimensional features of the scene of interest to generate the image data as three-dimensional image data.

20. The system of claim 17, wherein the user interface is further configured to enable the user to view the image data in one of a platform-centric view and a camera-perspective view, wherein the platform-centric view is associated with the location perspective of the user being offset from and substantially centered upon the rendered three-dimensional virtual representation of the monitoring platform, wherein the camera-perspective view is associated with the location perspective of the user being substantially similar to the perspective orientation of a respective one of the at least one video sensor system.
